(19) United States
(12) Patent Application Publication
(10) Pub. No.: US 2014/0292686 A1
(43) Pub. Date: Oct. 2, 2014

(54) ELECTRONIC DEVICE AND METHOD OF CONTROLLING THE SAME

(71) Applicant: Japan Display Inc., Minato-ku (JP)

(72) Inventors: Michio YAMAMOTO, Tokyo (JP); Jouji YAMADA, Tokyo (JP); Hirofumi NAKAGAWA, Tokyo (JP); Kohei AZUMI, Tokyo (JP); Makoto HAYASHI, Tokyo (JP); Hiroshi MIZUHASHI, Tokyo (JP); Kozo IKENO, Tokyo (JP); Yoshitoshi KIDA, Tokyo (JP)

(73) Assignee: Japan Display Inc., Minato-ku (JP)

(21) Appl. No.: 14/190,857

(22) Filed: Feb. 26, 2014

(30) Foreign Application Priority Data
Mar. 29, 2013 (JP) 2013-073872

(51) Int. Cl. G06F 3/041

(52) U.S. Cl. CPC G06F 3/041
USPC 345/173

(57) ABSTRACT

According to one embodiment, an electronic device includes a sensor-equipped display device including a pixel electrode, a common electrode opposed to the pixel electrode, and a detection electrode which is opposed to the common electrode, includes a plurality of segments, a display driver configured to supply a display signal to the pixel electrode and to supply a sensor driving signal or a common driving signal to the common electrode, a detection circuit configured to output to the display driver a data set including a sensor detection value from each of the segments of the detection electrode, based on the supplying of the sensor driving signal to the common electrode, and an application processor configured to receive the data set which has been output via the display driver from the detection circuit.

### CROSS-REFERENCE TO RELATED APPLICATIONS

This application is based upon and claims the benefit of priority from Japanese Patent Application No. 2013-073872, filed Mar. 29, 2013, the entire contents of which are incorporated herein by reference.

### FIELD

Embodiments described herein relate generally to an electronic device and a method of controlling the electronic device.

### BACKGROUND

In recent years, portable electronic devices, such as a mobile phone, a smartphone, a tablet terminal and a notebook-type personal computer, have been gaining in popularity. This type of electronic device includes, for example, an input panel which is formed integral with a display panel. For example, when a user has touched a display screen, the input panel detects the touch position. The input panel includes, for example, a sensor which detects a variation in electrostatic capacitance.

### BRIEF DESCRIPTION OF THE DRAWINGS

FIG. 1 is a block diagram which schematically illustrates a structure example of an electronic device of an embodiment.

FIG. 2 is a cross-sectional view which schematically illustrates a structure example of a sensor-equipped display device 10 shown in FIG. 1.

FIG. 3 is a perspective view for describing a structure example of a common electrode CE and a detection electrode SE of the sensor-equipped display device shown in FIG. 2.

FIG. 4 is a graph illustrating an example of a driving signal and a detection signal of an electrostatic capacitance-type sensor.

FIG. 5 is a plan view which schematically illustrates a structure example of an electronic device of an embodiment.

FIG. 6 is a cross-sectional view which schematically illustrates a structure example of an electronic device of an embodiment.

### DETAILED DESCRIPTION

In general, according to one embodiment, an electronic device includes: a sensor-equipped display device including a pixel electrode, a common electrode opposed to the pixel electrode, and a detection electrode which is opposed to the common electrode, includes a plurality of segments; a display driver configured to supply a display signal to the pixel electrode and to supply a sensor driving signal or a common driving signal to the common electrode; a detection circuit configured to output to the display driver a data set including a sensor detection value from each of the segments of the detection electrode, based on the supplying of the sensor driving signal to the common electrode; and an application processor configured to receive the data set which has been output via the display driver from the detection circuit.

According to another embodiment, an electronic device includes: a sensor-equipped display device including a pixel electrode, a common electrode which is opposed to the pixel electrode, includes a first segment extending in a first direction and is configured such that a plurality of the first segments are arranged in a second direction crossing the first direction, and a detection electrode which is opposed to the common electrode, includes a second segment extending in the second direction and is configured such that a plurality of the second segments are arranged in the first direction; a display driver configured to supply a display signal to the pixel electrode and to supply a sensor driving signal or a common driving signal to the common electrode; a detection circuit configured to output to the display driver a data set including a sensor detection value from each of the second segments of the detection electrode, based on the supplying of the sensor driving signal to the common electrode; and an application processor configured to receive the data set which has been output via the display driver from the detection circuit.

According to another embodiment, a method of controlling an electronic device including a sensor-equipped display device including a pixel electrode, a common electrode opposed to the pixel electrode, and a detection electrode which is opposed to the common electrode, includes a plurality of segments, the method includes: supplying a sensor driving signal to the common electrode from a display driver; receiving, by a detection circuit, a sensor detection value from each of the segments of the detection electrode, based on the supplying of the sensor driving signal to the common electrode; outputting to the display driver a data set including the sensor detection value received by the detection circuit; and receiving, by an application processor, the data set which has been output via the display driver from the detection circuit.

An electronic device of an embodiment and a method of controlling the electronic device will now be described in detail with reference to the accompanying drawings.

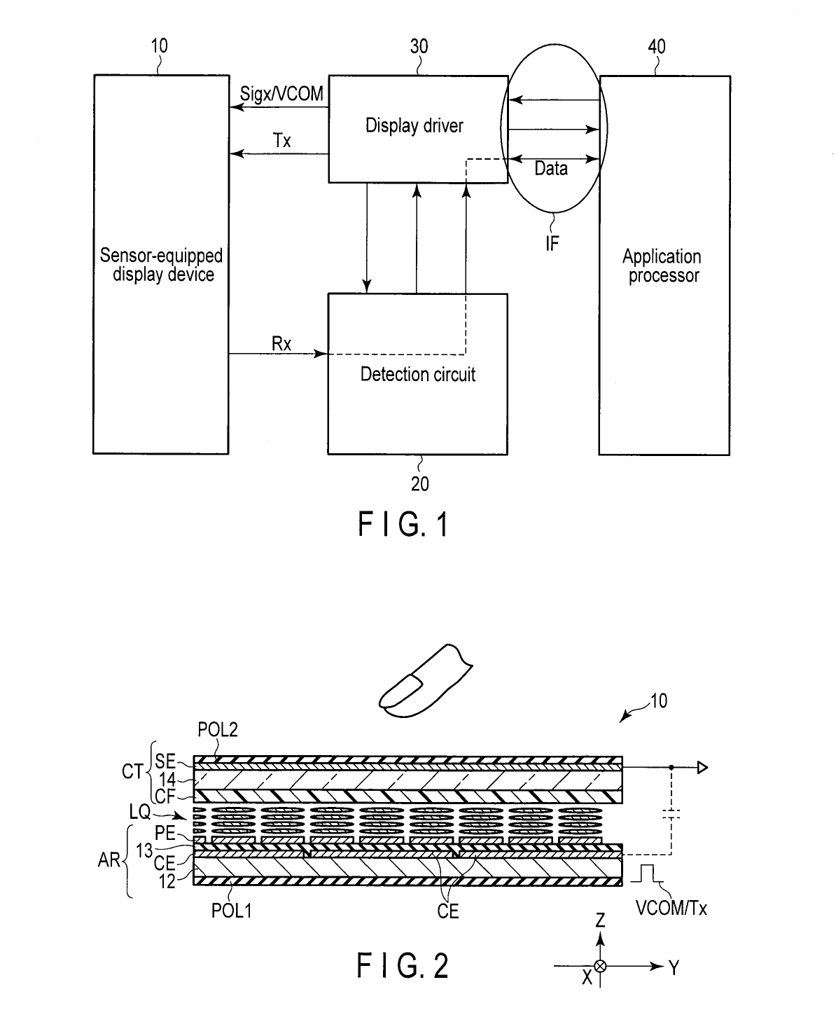

FIG. 1 is a block diagram which schematically illustrates a structure example of the electronic device of the embodiment.

The electronic device of the embodiment includes a sensor-equipped display device 10, a detection circuit 20, a display driver 30, and an application processor 40. The detection circuit 20 and display driver 30 are configured to be able to exchange various data. In addition, the display driver 30 and application processor 40 are configured to be able to exchange various data. For example, a DSI (Display Serial Interface) of an MIPI (Mobile Industry Processor Interface) is applicable as an interface IF for exchanging data between the display driver 30 and application processor 40. Incidentally, the interface IF between the display driver 30 and application processor 40 is not limited to the example illustrated here.

The sensor-equipped display device 10 includes a display device and a sensor. The sensor-equipped display device 10 displays, at a timing of image display, an image in accordance with a display signal Sigx and a common driving signal VCOM which has been received from the display driver 30. In addition, the sensor-equipped display device 10 drives, at a timing of sensing, the sensor in accordance with a sensor driving signal Tx which has been received from the display driver 30, and outputs a sensor detection value Rx to the detection circuit 20. The timing of sensing is set, for example, separately from the timing of image display.

The detection circuit 20 generates a data set Data by combining the sensor detection value Rx, which has been received from the sensor-equipped display device 10, with data corresponding to various information items, and outputs the data set Data to the display driver 30. In addition, the detection circuit 20 executes various data processes, which are not described in detail, and outputs signals to the display driver 30.

The display driver 30 processes graphic data, which has been received from the application processor 40, so that the sensor-equipped display device 10 can display the graphic data, and outputs the processed data to the sensor-equipped display device 10 as a display signal Sigx and the common driving signal Vcom. In addition, the display driver 30 outputs to the sensor-equipped display device 10 a sensor driving signal Tx for sensing in the sensor-equipped display device 10. In addition, the display driver 30 outputs the data set Data including the sensor detection value Rx, which has been received from the detection circuit 20, to the application processor 40.

The application processor 40 outputs various data, such as graphic data, to the display driver 30. In addition, the application processor 40 receives various data, such as the data set Data, from the display driver 30. Furthermore, the application processor 40 executes various processes by using raw data based on the sensor detection value Rx, the raw data being included in the data set Data received from the display driver 30.

The interface IF between the display driver 30 and the application processor 40 is configured such that at least a part of physical lanes executes both output of various data, such as graphic data, from the application processor 40 to the display driver 30, and output of various data, such as the data set Data, from the display driver 30 to the application processor 40. For example, in an identical physical lane of the interface IF, various data can be transferred in both directions between the application processor 40 and display driver 30. In this manner, when the identical physical lane is shared, the output of various data from the application processor 40 to display driver 30 and the output of various data from the display driver 30 to application processor 40 are executed at different timings (or in different transfer times). For example, in the identical physical lane, the output of graphic data from the application processor 40 to display driver 30 is executed at a timing of image display, and the output of the data set Data from the display driver 30 to application processor 40 is executed at a timing of sensing.

In the meantime, in the interface IF, only part of the physical lanes may be shared for data transfer between the display driver 30 and application processor 40, or all the physical lanes may be shared for data transfer.

In addition, in the example shown in FIG. 1, the case is illustrated that the data set Data is output from the display driver 30 to the application processor 40. However, the data set Data, which has been once received by the application processor 40, may be output to the display driver 30. Specifically, the data set Data can be transferred in both directions between the display driver 30 and application processor 40.

The application processor 40 in this embodiment is, for instance, a large scale integrated circuit (LSI) incorporated in an electronic device such as a mobile phone, and has a function of multiply executing a plurality of functional processes, such as Web browsing and multimedia processing, by software such as an OS. The application processor 40 executes high-speed arithmetic processes, and may be a dual-core or Quad-Core processor. The operation speed should preferably be, e.g. 500 MHz or more, and more preferably be 1 GHz.

FIG. 2 is a cross-sectional view which schematically illustrates a structure example of the sensor-equipped display device 10 shown in FIG. 1. In FIG. 2, a first direction X and a second direction Y are substantially perpendicular to each other, and a third direction Z is substantially perpendicular to a plane defined by the first direction X and second direction Y.

The sensor-equipped display device 10 is constructed by using a liquid crystal display device as the display device. In addition, the sensor-equipped display device 10 includes, as the sensor, an electrostatic capacitance-type sensor which is constructed by commonly using a part of electrodes (a common electrode CE to be described later) which are originally provided on the liquid crystal display device.

The sensor-equipped display device 10 includes an array substrate AR, a counter-substrate CT which is disposed to be opposed to the array substrate AR, and a liquid crystal layer LQ which is held between the array substrate AR and the counter-substrate CT.

The array substrate AR includes a first polarizer POL1, a TFT substrate 12, a common electrode CE, and a pixel electrode PE.

The TFT substrate 12 includes a transparent insulative substrate such as a glass substrate or a resin substrate, various wiring lines such as source lines and gate lines, switching elements connected to the source lines and gate lines, and an insulation film covering these parts. In a structure in which the gate lines extend in the first direction X and the source lines extend in the second direction Y, the switching elements are arranged in a matrix, for example, at intersections between the source lines and gate lines. The switching element switches a connection between the source line and pixel electrode PE by a signal which is supplied to the gate line. In the present embodiment, a thin-film transistor (TFT) is applicable as the switching element.

The common electrode CE is disposed on the TFT substrate 12 and is covered with an insulation layer 13. For example, pluralities of common electrodes CE extend in the first direction X and are arranged in the second direction Y. In other words, the common electrode CE is composed of a plurality of segments. A signal (common driving signal VCOM or sensor driving signal Tx) can be individually input to each of the segments of the common electrode CE. The common electrode CE is formed of a transparent, electrically conductive material such as ITO (Indium Tin Oxide) or IZO (Indium Zinc Oxide). In this embodiment, the common electrode CE is used also as a sensor driving electrode.

The pixel electrode PE is disposed on the insulation layer 13 and is covered with an alignment film (not shown). For example, pixel electrodes PE are arranged in a matrix having, for example, the first direction X as a row direction and the second direction Y as a column direction. Pluralities of columns of pixel electrodes PE, which are arranged in the first direction X, are opposed to one segment of the common electrode CE via the insulation layer 13.

Incidentally, in the example illustrated, three columns of pixel electrodes PE are opposed to one segment of the common electrode CE, but the structure is not limited to this example. A display signal Sigx is written in each pixel electrode PE via the switching element. The pixel electrode PE is formed of, for example, a transparent, electrically conductive material such as ITO or IZO. In the meantime, in an FFS (Fringe Field Switching) mode, each pixel electrode PE has a slit facing the common electrode CE, but the depiction of the slit is omitted here.

The first polarizer POL1 is disposed on a major surface on an outside (a side opposite to the common electrode CE) of the TFT substrate 12.

The counter-substrate CT includes a transparent insulative substrate 14 such as a glass substrate or a resin substrate, a color filter CF, a detection electrode SE, and a second polarizer POL2.

The color filter CF is disposed on an inside of the insulative substrate 14, that is, on a side thereof facing the array substrate AR. Incidentally, a black matrix, which is formed in a grid shape partitioning pixels, may be disposed on the inside of the insulative substrate 14. The color filter CF includes, for example, a plurality of color layers, and color layers of different colors are disposed in pixels neighboring in the first direction X. For example, the color filter CF includes color layers which are formed of resin materials that are colored in three primary colors of red, blue and green, respectively. A red color layer formed of a red-colored resin material is disposed in association with a red pixel. A blue color layer formed of a blue-colored resin material is disposed in association with a blue pixel. A green color layer formed of a green-colored resin material is disposed in association with a green pixel. The color filter CF is covered with an overcoat layer (not shown). The overcoat layer reduces the effect of asperities on the surface of the color filter CT. The overcoat layer is covered with an alignment film (not shown).

The detection electrode SE is disposed on an outside of the insulative substrate 14, that is, a major surface thereof opposite to the color filter CF. The detection electrode SE extends in a direction (second direction Y) which is substantially perpendicular to the direction (first direction X) in which the segments of the common electrode CE extend. In addition, pluralities of detection electrodes SE are arranged in the first direction X. In other words, the detection electrode SE is composed of a plurality of segments, and sensor detection values Rx can be individually output from the respective segments. This detection electrode SE, together with the common electrode CE, constitutes the sensor of the sensor-equipped display device 10. The detection electrode SE is formed of a transparent, electrically conductive material such as ITO or IZO.

The second polarizer POL2 is disposed on the detection electrode SE on the outside of the insulative substrate 14. A first polarization axis of the first polarizer POL1 and a second polarization axis of the second polarizer POL2 are arranged, for example, in an orthogonal positional relationship (crossed-Nicols).

Dielectric bodies, such as the liquid crystal layer LQ and insulative substrate 14, are interposed between the common electrode CE and the detection electrode SE.

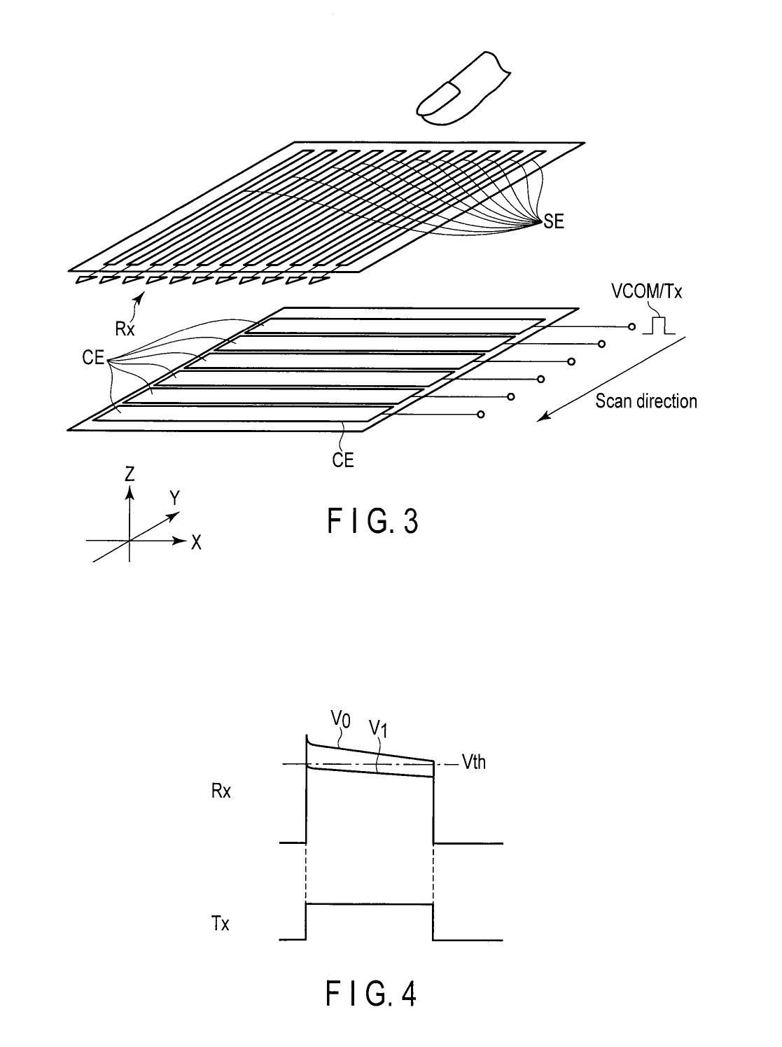

FIG. 3 is a perspective view for describing a structure example of the common electrode CE and detection electrode SE of the sensor-equipped display device shown in FIG. 2.

In the example illustrated, the common electrode CE is composed of a plurality of strip-shaped segments (first segments) extending in the first direction X. The detection electrode SE is composed of a plurality of strip-shaped segments (second segments) extending in the second direction Y.

At a timing of image display (display signal write time), a common driving signal VCOM is successively supplied from the display driver 30 to the segments of the common electrode CE, and line-sequential scan driving is executed in a time division manner.

At a timing of sensing (sensor driving time), a sensor driving voltage Tx is successively supplied from the display driver 30 to the respective segments of the common electrode CE. On the other hand, a sensor detection value Rx is output from each of the segments of the detection electrode SE, and is input to the detection circuit 20.

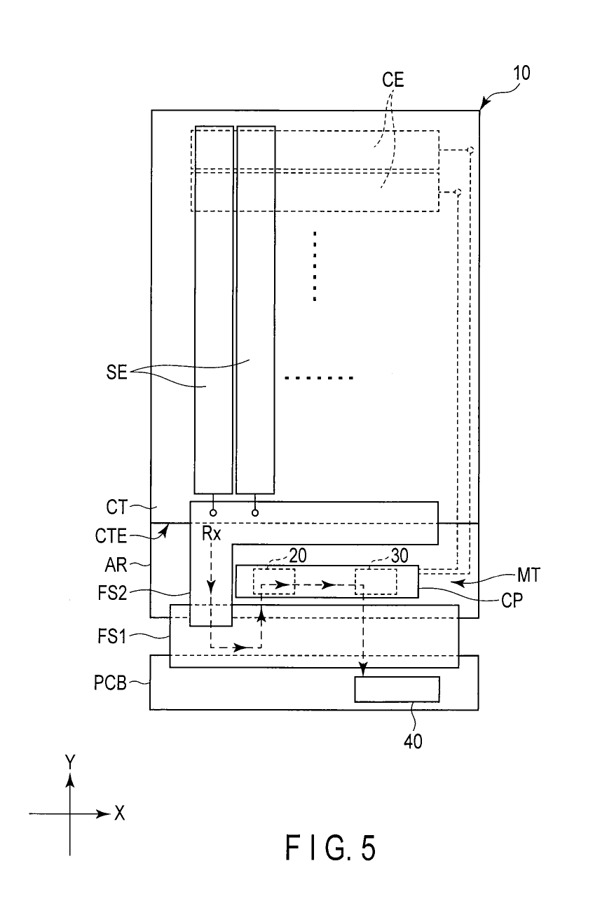

FIG. 4 is a graph illustrating an example of a driving signal and a detection signal of an electrostatic capacitance-type sensor.

The electrostatic capacitance-type sensor includes a pair of electrodes (common electrode CE and detection electrode SE) which are disposed to be opposed to each other, with a dielectric body being interposed, and constitute a first capacitance element.

The first capacitance element has one end connected to an AC signal source, and the other end grounded via a resistor and connected to the detection circuit 20 shown in FIG. 1. If a sensor driving signal Tx, which is an AC rectangular wave of a predetermined frequency (e.g. about several kHz to several-ten kHz), is applied from the AC signal source to the common electrode CE (i.e. one end of the first capacitance element), an output waveform (sensor detection value Rx), as shown in FIG. 4, appears at the detection detection SE (i.e. the other end of the first capacitance element).

In a state in which the user does not touch the sensor-equipped display device (or in a state in which the user is not in proximity to the sensor-equipped display device), a current corresponding to a capacitance value of the first capacitance element flows in accordance with charging/discharging of the first capacitance element. A potential waveform at the other end of the first capacitance element at this time is, for example, a waveform V0 shown in FIG. 4, and this is detected by the detection circuit 20.

On the other hand, in a state in which the user touches the sensor-equipped display device (or in a state in which the user is in proximity to the sensor-equipped display device), a second capacitance element, which is formed by, e.g. a finger of the user, is added in series to the first capacitance element. In this state, a current flows in accordance with charging/discharging of the first capacitance element and second capacitance element. A potential waveform at the other end of the first capacitance element at this time is, for example, a waveform V1 shown in FIG. 4, and this is detected by the detection circuit 20. At this time, the potential at the other end of the first capacitance element becomes a divided potential determined by the values of currents flowing in the first capacitance element and second capacitance element. Thus, the value of the waveform V1 becomes smaller than the value of the waveform V0 in the non-touch state. Accordingly, by comparing sensor detected value Rx with threshold value Vth, it becomes possible to determine whether the user touches the sensor-equipped display device.

The above description has been given of the method of detecting whether the user touches the sensor-equipped display device or not. However, even in the state in which the user does not touch the sensor-equipped display device, the sensor detection value Rx varies when the user is in proximity to the sensor-equipped display device, and therefore hovering detection, or the like, is also possible.

FIG. 5 is a plan view which schematically illustrates a structure example of an electronic device of an embodiment.

In the sensor-equipped display device 10, the array substrate AR includes a mounting portion MT which extends outward from a substrate end portion CTE of the counter-substrate CT. On the mounting portion MT, a driving IC chip CP is mounted by COG (Chip on Glass). In the example illustrated, the number of mounted driving IC chips CP is one. The driving IC chip CP includes the above-described detection circuit 20 and display driver 30. Specifically, exchange of data between the detection circuit 20 and display driver 30 is executed within the driving IC chip CP. The driving IC chip CP is connected to source lines and gate lines (not shown), and is connected to terminals of the segments of the common electrode CE. In the meantime, although the structure in which one driving IC chip CP includes the detection circuit 20 and display driver 30 is illustrated, the structure is not limited to this example. The detection circuit 20 and display driver 30 may be included in separate driving IC chips, respectively.

The application processor 40 is mounted, for example, on a printed circuit board PCB of the electronic device body. The sensor-equipped display device 10 and the printed circuit board PCB are connected via a first flexible printed circuit board FS1. Specifically, one end portion of the first flexible printed circuit board FS1 is connected to a substrate end portion side of the array substrate AR, relative to the driving IC chip CP, on the mounting portion MT. The first flexible printed circuit board FS1 and the driving IC chip CP are connected via wiring formed on the mounting portion MT. The other end portion of the first flexible printed circuit board FS1 is connected to the printed circuit board PCB.

On the other hand, in the sensor-equipped display device 10, a second flexible printed circuit board FS2 is connected to an outer surface of the counter-substrate CT. Specifically, one end portion of the second flexible printed circuit board FS2 is connected to terminals of the respective segments of the detection electrode SE which is located on the outer surface of the counter-substrate CT. Although the other end portion of the second flexible printed circuit board FS2 is connected to, for example, the first flexible printed circuit board FS1, the other end portion of the second flexible printed circuit board FS2 may be directly mounted on the mounting portion MT.

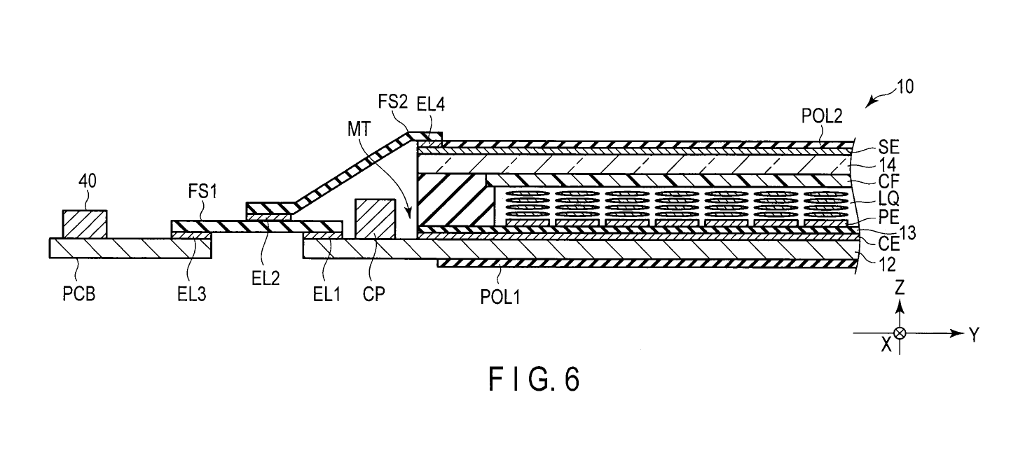

FIG. 6 is a cross-sectional view which schematically illustrates a structure example of an electronic device of an embodiment.

The first flexible printed circuit board FS1 includes, on its inner surface, that is, on its surface on a side facing the TFT substrate 12, an electrode EL1 for connection to the TFT substrate 12. In addition, the first flexible printed circuit board FS1 includes, on its outer surface, that is, on its surface on a side facing the second flexible printed circuit board FS2, an electrode EL2 for connection to the second flexible printed circuit board FS2. Further, the first flexible printed circuit board FS1 includes an electrode EL3 for connection to the printed circuit board PCB, and various wiring lines for connecting these electrodes. The electrode EL2 on the outer surface side is electrically connected to wiring, etc. on the inner surface side via a through-hole. In the example illustrated, although the printed circuit board PCB is connected to the inner surface side of the first flexible printed circuit board FS1, the printed circuit board PCB may be connected to the outer surface side of the first flexible printed circuit board FS1.

The second flexible printed circuit board FS2 includes, on its inner surface, that is, on its side facing the insulative substrate 14, an electrode EL4 for connection to a terminal of the detection electrode SE, which is exposed from the second polarizer POL2. In addition, the second flexible printed circuit board FS2 includes, on its inner surface, various wiring lines for connecting the electrode EL2 and electrode EL4.

According to this structure, at a timing of image display, graphic data, which has been output from the application processor 40, is input to the driving IC chip CP via wiring lines on the printed circuit board PCB and wiring lines on the first flexible printed circuit board FS1. The driving IC chip CP generates, by the display driver 30, a display signal Sigx and a common driving signal VCOM, based on the received graphic data. The display signal Sigx, which has been output from the driving IC chip CP, is written in each pixel electrode PE, and the common driving signal VCOM, which has been output from the driving IC chip CP, is input to each segment of the common electrode CE.

On the other hand, at a timing of sensing, a sensor driving signal Tx, which has been output from the driving IC chip CP, is input to each segment of the common electrode CE. At this time, a sensor detection value Rx, which has been output from each segment of the detection electrode SE, is input to the detection circuit 20 of the driving IC chip CP via wiring lines on the second flexible printed circuit board FS2 and wiring lines on the first flexible printed circuit board FS1. The driving IC chip CP outputs, from the display driver 30, a data set Data including raw data based on the received sensor detection value Rx. The data set Data, which has been output from the display driver 30, is input to the application processor 40 via wiring lines on the first flexible printed circuit board FS1 and wiring lines on the printed circuit board PCB.

Specifically, in the example illustrated, the output path of the sensor detection value Rx, which has been output from the detection electrode SE, is as follows: the second flexible printed circuit board FS2 [symbol] 0 first flexible printed circuit board FS1 [symbol] driving IC chip CP [symbol] first flexible printed circuit board FS1 [symbol] application processor 40.

In the meantime, when the other end portion of the second flexible printed circuit board FS2 is directly mounted on the mounting portion MT, the output path of the sensor detection value Rx, which has been output from the detection electrode SE, may be as follows: the second flexible printed circuit board FS2 [symbol] driving IC chip CP [symbol] first flexible printed circuit board FS1 [symbol] application processor 40.

In each of the examples, as described above, the DSI (Display Serial Interface), for instance, is applicable as the interface for communicating the data set Data between the driving IC chip CP and display driver 30.

The application processor 40 executes various processes by using raw data based on the sensor detection value Rx, from the received data set Data.

According to the present embodiment, by outputting the data set Data including the sensor detection value Rx directly to the application processor 40, various processes using the data set Data can be executed on the application processor 40 side. By such processes on the application processor 40 side, not merely coordinate information of touch or proximity of the user can be obtained from the data set Data, but three-dimensional information including a coordinate position and a physical amount can also be obtained based on the sensor detection value Rx detected by the sensor of the sensor-equipped display device 10.

In addition, the configuration of the application processor 40 may be realized by hardware or software. In any case, the application processor 40 controls the detection circuit 20 and display driver 30, and executes arithmetic operations using the raw data. Thus, the configurations of the sensor-equipped display device 10, detection circuit 20 and display driver 30 are simplified. According to the present embodiment, an electronic device with a wide range of general-purpose uses and a method of controlling the electronic device can be provided.

Furthermore, with an increasing demand for higher fineness of the sensor and for larger of screen size of the sensor-equipped display device 10, the data amount of the sensor detection value Rx increases. However, in the detection circuit 20 and display driver 30 which are incorporated in the driving IC chip CP, since a process, such as coordinate detection based on the sensor detection value Rx, is not executed, it is possible to provide an inexpensive, compact electronic device which is not required to increase the processing capability, the circuit scale, the memory capacity, etc of the driving IC chip CP.

In particular, a simple configuration can be realized by setting the number of driving IC chips CP, which are mounted on the sensor-equipped display device 10, to be one. In addition, data exchange between the driving IC chip CP and the application processor 40 can be executed by only the interface between the display driver 30 and application processor 40, and the number of pins for connecting both components can be reduced, and therefore a simpler configuration can be realized.

The above description has been given of the structure in which the sensor-equipped display device includes the liquid crystal display device as the display device. Alternatively, the sensor-equipped display device may be configured to include another type of display device, such as an organic electroluminescence display device. In addition, in the example illustrated in FIG. 2, etc., the description has been given of the structure of the liquid crystal display device in which both the pixel electrode PE and common electrode CE are provided on the array substrate AR, that is, a structure in which a lateral electric field (including a fringe electric field) is mainly used, such as an IPS (In-Plane Switching) mode or an FFS (Fringe Field Switching) mode. However, the structure of the liquid crystal display device is not limited to this example. At least the pixel electrode PE is provided on the array substrate AR, and the common electrode CE may be provided on either the array substrate AR or the counter-substrate CT. In the case of a structure in which a vertical electric field is mainly used, like a TN (Twisted Nematic) mode, an OCB (Optically Compensated Bend) mode or a VA (Vertical Aligned) mode, the common electrode CE is provided on the counter-substrate CT. In short, it should suffice if the position of disposition of the common electrode CE is between the TFT substrate 12, which constitutes the array substrate AR, and the insulative substrate 14, which constitutes the counter-substrate CT.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a sensor-equipped display device including a pixel electrode, a common electrode opposed to the pixel electrode, and a detection electrode which is opposed to the common electrode, includes a plurality of segments;
a display driver configured to supply a display signal to the pixel electrode and to supply a sensor driving signal or a common driving signal to the common electrode;
a detection circuit configured to output to the display driver a data set including a sensor detection value from each of the segments of the detection electrode, based on the supplying of the sensor driving signal to the common electrode; and
an application processor configured to receive the data set which has been output via the display driver from the detection circuit.

2. The electronic device of claim 1, further comprising an interface for exchanging data between the display driver and the application processor,
wherein the interface includes a physical lane for executing output of graphic data from the application processor to the display driver, and output of the data set from the display driver to the application processor.

3. The electronic device of claim 2, wherein the output of the graphic data and the output of the data set are executed by using an identical said physical lane at different timings.

4. The electronic device of claim 1, wherein a DSI (Display Serial Interface) is applied as an interface for communicating the data set between the display driver and the application processor.

5. The electronic device of claim 1, wherein the display driver and the detection circuit are incorporated in one driving IC chip mounted on the sensor-equipped display device.

6. The electronic device of claim 5, wherein the sensor-equipped display device includes an array substrate on which the driving IC chip is mounted and which includes the pixel electrode, and a counter-substrate including the detection electrode, and
the electronic device further comprises a first flexible printed circuit board having a first end portion connected to the array substrate, and a second flexible printed circuit board having a second end portion connected to the detection electrode and a third end portion connected to the first flexible printed circuit board or the array substrate.

7. The electronic device of claim 6, wherein the array substrate includes the common electrode.

8. An electronic device comprising:
a sensor-equipped display device including a pixel electrode, a common electrode which is opposed to the pixel electrode, includes a first segment extending in a first direction and is configured such that a plurality of the first segments are arranged in a second direction crossing the first direction, and a detection electrode which is opposed to the common electrode, includes a second segment extending in the second direction and is configured such that a plurality of the second segments are arranged in the first direction;
a display driver configured to supply a display signal to the pixel electrode and to supply a sensor driving signal or a common driving signal to the common electrode;
a detection circuit configured to output to the display driver a data set including a sensor detection value from each of the second segments of the detection electrode, based on the supplying of the sensor driving signal to the common electrode; and
an application processor configured to receive the data set which has been output via the display driver from the detection circuit.

9. The electronic device of claim 8, further comprising an interface for exchanging data between the display driver and the application processor,
wherein the interface includes a physical lane for executing output of graphic data from the application processor to the display driver, and output of the data set from the display driver to the application processor.

10. The electronic device of claim 9, wherein the output of the graphic data and the output of the data set are executed by using an identical said physical lane at different timings.

11. The electronic device of claim 8, wherein a DSI (Display Serial Interface) is applied as an interface for communicating the data set between the display driver and the application processor.

12. The electronic device of claim 8, wherein the display driver and the detection circuit are incorporated in one driving IC chip mounted on the sensor-equipped display device.

13. The electronic device of claim 12, wherein the sensor-equipped display device includes an array substrate on which the driving IC chip is mounted and which includes the pixel electrode, and a counter-substrate including the detection electrode, and
the electronic device further comprises a first flexible printed circuit board having one end portion connected to the array substrate, and a second flexible printed circuit board having one end portion connected to the detection electrode and the other end portion connected to the first flexible printed circuit board or the array substrate.

14. The electronic device of claim 13, wherein the array substrate includes the common electrode.

15. A method of controlling an electronic device including a sensor-equipped display device including a pixel electrode, a common electrode opposed to the pixel electrode, and a detection electrode which is opposed to the common electrode, includes a plurality of segments, the method comprising:
supplying a sensor driving signal to the common electrode from a display driver;
receiving, by a detection circuit, a sensor detection value from each of the segments of the detection electrode, based on the supplying of the sensor driving signal to the common electrode;
outputting to the display driver a data set including the sensor detection value received by the detection circuit; and
receiving, by an application processor, the data set which has been output via the display driver from the detection circuit.

16. The method of claim 15, wherein output of graphic data from the application processor to the display driver and output of the data set from the display driver to the application processor are executed by using an identical physical lane.

17. The method of claim 16, wherein the output of the graphic data and the output of the data set are executed at different timings.
